(19) United States
(12) Patent Application Publication
(10) Pub. No.: US 2022/0221574 A1
(43) Pub. Date: Jul. 14, 2022

(54) CAMERA AND RADAR SENSOR SYSTEM AND ERROR COMPENSATION METHOD THEREOF

(71) Applicant: MOVON CORPORATION, Seoul (KR)

(72) Inventors: Younkyu CHUNG, Seoul (KR); Yong Jeong PARK, Seoul (KR); Chenglin CUI, Gyeonggi-do (KR); Pyounghwa YOON, Seoul (KR); Hyun Woo SEO, Seoul (KR)

(21) Appl. No.: 17/552,359

(22) Filed: Dec. 16, 2021

(30) Foreign Application Priority Data
Jan. 11, 2021 (KR) 10-2021-0003243
Apr. 28, 2021 (KR) 10-2021-0055139

(51) Int. Cl. G01S 13/86; G06T 7/70; G06T 7/20; H04N 5/247; G06T 7/50; H04N 17/00; G01S 13/931; B60R 11/04

(52) U.S. Cl. CPC G01S 13/867; G06T 7/70; G06T 7/20; H04N 5/247; B60R 2011/0026; H04N 17/002; G01S 13/931; B60R 11/04; G06T 2207/30252; G06T 7/50

(57) ABSTRACT

A sensor system includes a camera module and a radar module, wherein the camera module and the radar module are housed separately and detachably, and the sensor system is mounted in a cabin of a vehicle.

### CROSS-REFERENCE TO RELATED APPLICATION

This application claims priority to and the benefit of Korean Patent Applications of No. 10-2021-0003243, filed on Jan. 11, 2021 and No. 10-2021-0055139, filed on Apr. 28, 2021 and the disclosure of which is incorporated herein by reference in its entirety.

### BACKGROUND

### 1. Field of the Invention

The techniques set forth herein are related to a camera and radar sensor system and an error compensation method thereof.

### 2. Discussion of Related Art

Fatality rates of collision accidents occurring during high-speed driving of vehicles are high and such an accident may cause a chain collision accident leading to a big accident. Generally, forward collision accidents occur due to a failure to keep a sufficient distance between vehicles to avoid collision due to drivers' carelessness or difficulties in securing a field of view that is caused by bad weather. In particular, a driver's limited visual ability and a response delay time required to recognize and decide a dangerous situation have a great influence on a chain collision accident of vehicles moving at high speeds.

Recently, technologies for fixing such a problem and providing safe driving conditions are being studied.

### SUMMARY OF THE INVENTION

Driver warning devices of the related art include sensors divided and installed in various parts of a vehicle and a controller installed in an engine room. Therefore, when the sensors are installed, brackets for fixing the sensors for transmitting signals to the controller, a power cable for supplying power to the sensors, and a communication cable for providing a detected signal to the controller are needed. These factors may be largely influenced by electromagnetic waves generated in the engine room and electromagnetic waves introduced from the outside, and thus a serious error may occur in data transmission.

One of aspects of embodiments set forth herein is for solving the above-described problem of the related art. That is, embodiments are directed to providing a sensor system capable of minimizing external influences and generating fewer errors.

Embodiments are also directed to providing a sensor system capable of combining one of camera modules having different field-of-view (FOV) angles and/or different resolutions and one of radar modules of different detection ranges according to a user's selection.

An embodiment provides a camera and radar sensor system including a camera module and a radar module, wherein the camera module and the radar module are separately and detachably housed, and the camera and radar sensor system is mounted in a cabin of a vehicle.

The camera and radar sensor system of the embodiment is applicable to devices such as a driver warning device and an autonomous emergency braking (AEB) system.

According to an aspect of the embodiment, a data transceiving connector may be provided at positions corresponding to a camera housing for housing the camera module and a radar housing for housing the radar housing.

According to an aspect of the embodiment, the radar module may include a radar processor configured to calculate a position and movement information of an object from radio waves reflected from the object, the camera module may include a camera processor configured to calculate the position and movement information of the object from a captured image, and the camera processor may receive the position and movement information of the object that are calculated by the radar processor, and create and output a driver warning with respect to the object.

According to an aspect of the embodiment, the sensor system may be mounted on a windshield of the vehicle.

According to an aspect of the embodiment, the camera module may be one of a first camera module and a second camera module with different field-of-view (FOV) angles, and the radar module may be one of a first radar module and a second radar module with different detection ranges.

According to an aspect of the embodiment, the detection range of the first radar module may be less than 100 nm, and the detection range of the second radar module may be 100 nm or more.

According to an aspect of the embodiment, the first radar module may use radio waves of 79 GHz, and the second radar module may use radio waves of 77 GHz.

According to an aspect of the embodiment, the first radar module may be one of two-dimensional (2D) radar, three-dimensional (3D) radar, and four-dimensional (4D) radar, and the second radar module may be another one of the 2D radar, the 3D radar, and the 4D radar.

According to an aspect of the embodiment, the FOV angle of the first camera module may be less than 60 degrees, and the FOV angle of the second camera module may be 60 degrees or more.

According to an aspect of the embodiment, the first camera module may have a resolution of less than FHD (1920×1080), and the second camera module may have a resolution of FHD (1920×1080) or more.

According to an aspect of the embodiment, the radar module may include a transmitter configured to transmit radio waves, a receiver configured to receive radio waves reflected from an object, and a radar processor configured to control the transmitter to transmit the radio waves, and calculate at least one of a distance to the object and a speed of the object from the reflected radio waves.

According to an aspect of the embodiment, the radar module may further include a radar interface configured to output formed object information to at least one of an external warning device and the camera module.

According to an aspect of the embodiment, the camera module may include an imaging unit configured to capture an image of a moving direction of the vehicle, a camera processor configured to calculate whether there is an object, a speed of the object, and a distance to the object from the image captured by the imaging unit, and a camera interface configured to output information about whether there is an object, the speed of the object, and the distance to the object that are calculated by the camera processor.

An embodiment provides an error compensation method of a camera module and a radar module, the error compensation method including: (a) calculating the sum of an angle of deviation of a center axis of the camera module and an angle of deviation of a center axis of the radar module after assembling the camera module and the radar module, (b) calculating an angle of deviation of one of the camera module and the radar module after mounting the camera module and the radar module in a vehicle, and (c) calculating an angle of deviation of the other camera module or radar module by subtracting the angle of deviation of the one of the camera module and the radar module from the sum of the angles of deviation.

According to an aspect of the embodiment, (a) may include (a1) forming a reference center axis connecting a center of an integrated target, which includes a camera target of a camera module and a radar target of a radar module, and a center of an assembly of the camera module and the radar module, and (a2) calculating an angle between a camera center axis viewed from the camera module and a radar center axis viewed from the radar module.

According to an aspect of the embodiment, (b) may include (b1) calculating an ideal angle from distances between central points on the camera module and the radar module and centers of a camera target and a radar target and distances from the central points on the camera module and the radar module to the camera module or the radar module, (b2) calculating an angle of a center axis that is beyond the ideal angle when viewed from one of the camera module and the radar module, and (b3) calculating a difference between the ideal angle and an angle formed by a center axis viewed from one of the camera module and the radar module to calculate an angle of deviation of the one of the camera module and the radar module.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view showing an overview of a sensor system according to an embodiment;

FIG. 2A is a front view of a camera module, and FIG. 2B is a side view of the camera module;

FIG. 3 is a diagram showing an overview of a radar module;

FIG. 4 is a block diagram of a state in which the camera module and the radar module are combined with each other;

FIG. 5 is a flowchart of an overview of an error compensation method according to an embodiment;

FIG. 6 is a diagram illustrating an overview of calculating an offset angle between a center axis of the camera module and a center axis of the radar module;

FIG. 7A is a diagram illustrating a case in which both a measured angle of deviation θc1 and an angle of deviation θᵣ₁ are values with a positive sign, and FIG. 7B is a diagram illustrating a case in which both the measured angle of deviation θc1 and the angle of deviation θᵣ₁ are values with opposite signs;

FIG. 8 is a diagram illustrating a case in which a deviation corresponding to an angle of installation occurs to both a center axis of the camera module and a center axis of the radar module when the camera module and the radar module are installed; and

FIGS. 9 and 10 are diagrams for describing an error compensation process.

### DETAILED DESCRIPTION OF EXEMPLARY EMBODIMENTS

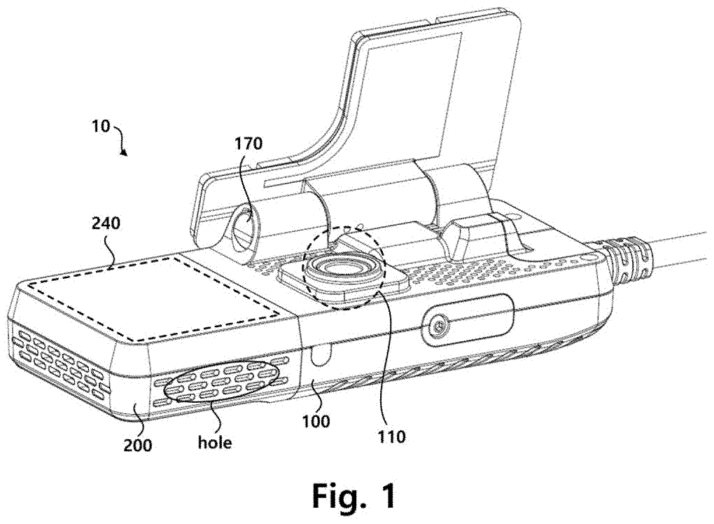

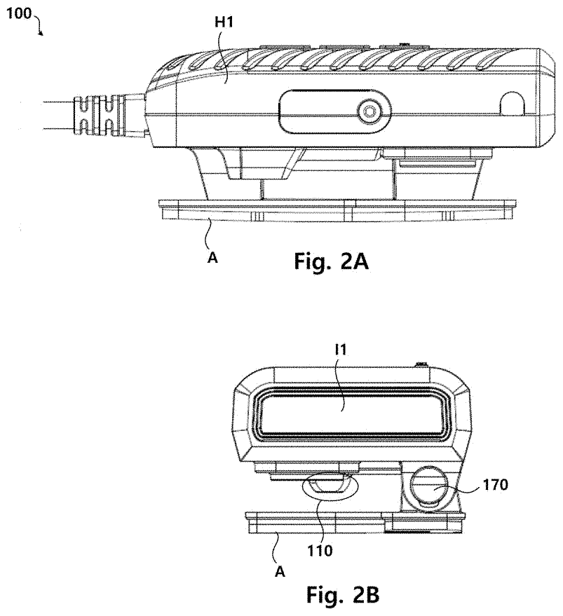

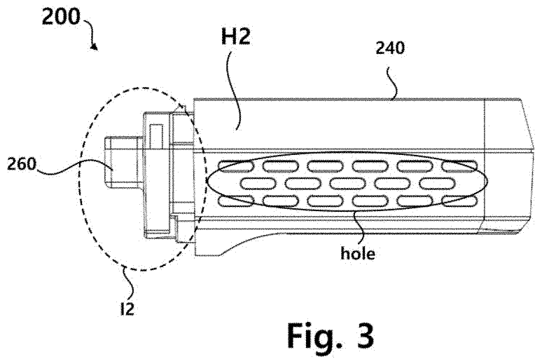

Hereinafter, a sensor system 10 according to the present embodiment will be described with reference to the accompanying drawings. FIG. 1 is a perspective view showing an overview of a sensor system 10 according to an embodiment. FIG. 2A is a diagram illustrating one side of a camera module 100. FIG. 2B is a diagram illustrating another side of the camera module 100. FIG. 3 is a diagram illustrating one side of a radar module 200.

Referring to FIGS. 1 to 3, the sensor system 10 according to the present embodiment includes the camera module 100 and the radar module 200. The camera module 100 is housed in a camera housing H1, and the radar module 200 is housed in a radar housing H2 different than the camera housing H1. The camera module 100 and the radar module 200, which are housed separately from each other, may be combined with each other to form the sensor system 10.

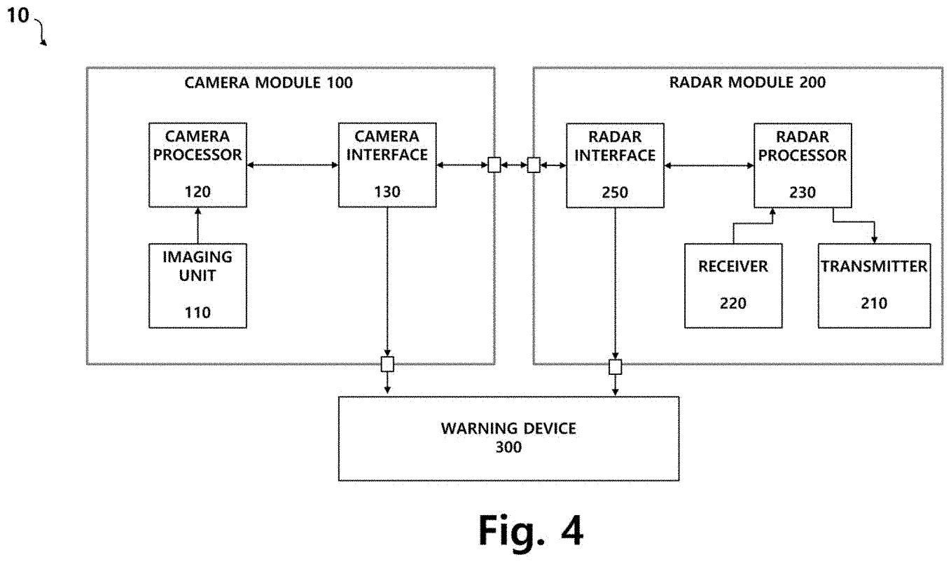

An imaging unit 110 of the camera module 100 captures an image of a moving direction of a vehicle and provides the captured image to a camera processor 120 (see FIG. 4). In the radar module 200, a radar transmitter 210 (see FIG. 4) transmits radio waves through a radio wave transceiving surface 240 facing the moving direction of the vehicle, and a receiver 220 (see FIG. 4) receives radio waves reflected from an object.

In embodiments illustrated in FIGS. 2B and 3, a coupling member Il is located on a side surface of the camera module 100, and a coupling member 12 is located on a side surface of the radar module 200 corresponding to the side surface of the camera module 100. In the illustrated embodiments, the coupling member 12 of the radar module 200 is a protruding portion, and the coupling member It of the camera module 100 is an insertion portion into which the protruding portion is inserted. According to an embodiment not shown herein, a coupling member of a radar module is an insertion portion and a coupling member of a camera module is a protruding portion inserted into the insertion portion.

A connector 260 is provided on the protruding portion 12 of the radar module 200 to provide position and moving information of an object calculated by the radar module 200 to the camera module 100 or receive position and moving information of the object from the camera module 100. Similarly, a connector (not shown) is located on the insertion portion of the camera module 100 to transmit or receive data, when connected to the connector 260. As described below, object information, including a distance to an object, the size of the object, and speed information, which is formed by the radar module 200, may be provided to the camera module 100 or an external warning device (not shown) through a radar interface 250.

As another example, when a radar module and a camera module are combined with each other, camera module image processing information such as lane information may be provided to the radar module through a camera interface. Radar-camera data fusion may be implemented using a module coupling structure.

In an embodiment not shown herein, a radar interface and a camera interface transmit and receive information using a wireless communication protocol such as Bluetooth, ZigBee, or Wi-Fi.

Holes may be formed in the radar housing H2 of the radar module 200. Heat generated in a transmitter, a receiver, a radar interface, and a radar processor which are inner components may be dissipated through the holes.

Referring to FIGS. 1 and 2A, the camera module 100 may include an imaging unit 110 configured to capture an image of an object and provide the image to the camera processor 120 (see FIG. 4), and a hinge structure 170 provided on the camera housing H. In an embodiment, the camera module 100 further includes a lens hood that blocks stray light, which is generated when sunlight is reflected from a dashboard of a vehicle or a surface of the road, from coming into the imaging unit 110. The lens hood prevents the quality of a captured image from deteriorating due to stray light coming into the imaging unit 110.

In an embodiment, a side surface A of the hinge structure 170 may be a mounting surface A attached to a windshield of the vehicle. On the mounting surface A, an adhesive such as adhesive tape may be provided, and a suction plate formed of a material such as rubber may be provided although not shown. Thus, the radar module 200 may be fixed on the camera module 100 to be mounted in the vehicle at the same angle as the camera module 100 with respect to the windshield.

In the embodiments of FIGS. 1 and 2A, the hinge structure 170 is illustrated as being provided on the camera module 100, but in an embodiment not shown here, a hinge structure may be provided on a radar module and a camera module may be fixed on the radar module and mounted in a vehicle.

FIG. 4 is a block diagram illustrating a state in which the camera module 100 and the radar module 200 are combined with each other. Referring to FIG. 4, the radar module 200 includes a transmitter 210 configured to transmit radio waves under control of a radar processor 230, a receiver 220 configured to receive radio waves reflected from an object (not shown), the radar processor 230 configured to control the transmitter 210, form object information by calculating at least one of a distance to an object, the size of the object, and a speed of the object from the reflected radio waves, and a radar interface 250 configured to output the object information. In an embodiment, the radar interface 250 may receive object information detected by the camera module 100 and provide the object information to the radar processor 230.

The radar module 200 may be classified as a first radar module or a second radar module according to a wavelength band of radio waves transmitted from the transmitter 210. For example, the first radar module may transmit radio waves of 79 GHz band to detect an object within a short distance of less than 100 m. The second radar module may transmit radio waves of 77 GHz band to detect an object within a middle or long distance of 100 m or more. A user may select a radar module according to object detection characteristics of the first and second radar modules and his or her intention and use the selected radar module in combination with the camera module 100.

As another example, the first radar module may be one of a two-dimensional (2D) radar for detecting an object on a plane, a three-dimensional (3D) radar for detecting an object in a space, and a four-dimensional (4D) radar for detecting not only an object but also a speed of the object, and the second radar module may be another one of the 2D, the 3D, and the 4D radar.

The radar processor 230 forms object information, including a distance to an object, a position of the object, the size of the object, a speed of the object, etc., from radio waves received by the receiver 220. As described above, the radar processor 230 detects at least one of a plane including an object, a space, and the speed of the object in the space, and forms object information about a result of the detection.

The radar interface 250 receives the object information formed by the radar processor 230. In an embodiment, the radar interface 250 may provide the object information to the camera interface 130 through the connector 260. In another embodiment, the radar interface 250 receives object information, which is formed by the camera processor 120, through the camera interface 130.

The radar interface 250 may provide object information formed by the radar processor 230 to the camera interface 130 using a wireless communication protocol such as Bluetooth, ZigBee or Wi-Fi, and the camera interface 130 may provide an object interface formed by the camera processor 120 to the radar interface 250 using a wireless communication protocol such as Bluetooth, ZigBee or Wi-Fi.

In another embodiment, the radar module 200 may be used as standalone. When the radar module 200 is used as standalone, the radar interface 250 may transmit object information to or receive object information from an external warning device 300. The object information may be transmitted and received through wired communication using the connector 260 illustrated in FIG. 3 or a separate connector (not shown). As another example, the radar interface 250 and the external warning device 300 may transmit and receive object information using the wireless communication protocol described above.

The camera module 100 includes the imaging unit 110 configured to form an image, the camera processor 120 configured to form object information by calculating as to whether there is an object, a speed of the object, and a distance to the object from an image captured by the imaging unit 110, and the camera interface unit 130 configured to output the object information, including whether there is an object, the speed of the object, and the distance to the object, calculated by the camera processor 120.

In an embodiment, the imaging unit 110 may include at least one of a CMOS image sensor and a CCD sensor. The imaging unit 110 may include a lens unit (not shown) for performing optical processing such as concentrating light and/or spreading light into a spectrum. The imaging unit 110 photographs a moving direction of a vehicle, forms an image consisting of several frames per unit time, and provides the image to the camera processor 120.

The camera module 100 may be classified as a first camera module or a second camera module according to a field-of-view (FOV) angle at which photographing of the imaging unit 110 is performed. For example, the first camera module may be a narrow-angle camera module with an FOV angle of less than 60 degrees and may be capable of capturing an image of an object located remotely from the camera module 100. The second camera module may be a wide-angle camera module with an FOV angle of 60 degrees or more and may be capable of capturing an image of an object located within a shorter distance than the first camera module. As another example, the first camera module and the second camera module may form images of different resolutions. For example, the first camera module may have a resolution of less than FHD (1920×1080), and the second camera module may have a resolution of greater than or equal to FHD (1920×1080).

A user may select a camera module according to object detection characteristics of the first and second camera modules and his or her intention and use the selected camera module in combination with the radar module 200.

The camera processor 120 may receive object information provided by the radar module 200 from the camera interface 130 and form object information by adding thereto information about whether there is an object, a speed of the object, a distance to the object, and the like from images captured and provided by the imaging unit 110. In another embodiment, the camera processor 120 may receive object information provided by the camera module 100 from the camera interface 130 and form object information by adding thereto object information about whether there is an object, a speed of the object, a distance to the object, and the like from radio waves received by the receiver 220.

For example, the radar module 200 may be superior to the camera module 100 in terms of object detection characteristics in a bad weather environment, e.g., fog, heavy snowfall, or heavy rain, when there is no illumination, and the camera module 100 may be superior to the radar module 200 in terms of object recognition and traverse position detection for detecting whether an object is currently driving in a current lane or is driving in an adjacent lane. Accordingly, the camera module 100 may use both object information generated from an image provided by the imaging unit 110 and object information provided by the radar module 200 to achieve a higher level of object detection and recognition characteristics than when the camera module 100 is used alone. For example, even when a calculated distance to an object decreases sharply in a bad weather environment, a user may be provided with a warning about collision to prevent collision.

Object information formed by the camera processor 120 is provided to the camera interface 130. The camera interface 130 may provide the object information to the external warning device 300, and the external warning device 300 may provide a user with a warning on the basis of the object information provided. For example, the camera interface 130 and the external warning device 300 transmit and receive object information through wired communication using a separate connector (not shown) and/or a wireless communication protocol such as Bluetooth, ZigBee, or Wi-Fi.

Object information formed by the radar processor 230 is provided to the radar interface 250. The radar interface 250 may provide the object information to the external warning device 300, and the external warning device 300 may provide a user with a warning on the basis of the object information. For example, the radar interface 250 and the external warning device 300 transmit and receive object information through wired communication using a separate connector (not shown) and/or a wireless communication protocol such as Bluetooth, ZigBee, or Wi-Fi.

In an embodiment not shown here, the camera module 100 and/or the radar module 200 may be used as standalone. When the camera module 100 and the radar module 200 are used as standalone, the camera interface 130 and the radar interface 250 may transmit object information to or receive object information from the external warning device 300. The object information may be transmitted and received through wired communication using a separate connector (not shown). As another example, the camera interface 130 and the external warning device 300 and/or the radar interface 250 and the external warning device 300 may transmit and receive object information using the wireless communication protocol described above.

The external warning device 300 (see FIG. 4) may be a device that displays a warning to a driver of a vehicle according to a position and movement information of an object and may be a light-emitting device, a display device, a speaker that provides an audio warning to the user and the like.

A collision warning signal formed by the camera processor 120 is provided to the camera interface 130. The camera interface 130 performs interfacing with the camera processor 120 and a warning device (not shown), which includes a light-emitting device and a display, to allow the warning device to provide a user with a warning according to a signal output from the camera processor 120.

In the embodiments of FIGS. 1 and 4, a case in which the camera module 100 and the radar module 200 are operated while being combined with each other is illustrated. However, as described above, each of a camera module and a radar module may be operated as standalone to provide the external warning device 300 with object information formed by detecting an object so that a user may be provided with a warning.

According to the present embodiment, the camera module 100 and the radar module 200 may be separated from each other, and an object may be more exactly detected using different advantages of the camera module 100 and the radar module 200. Furthermore, effects on a module due to noise generated in another module may be reduced.

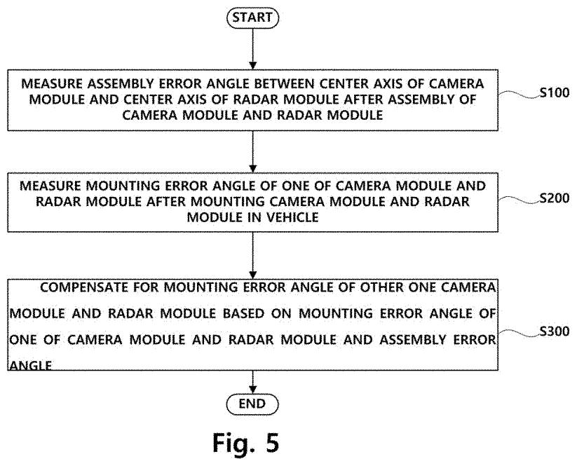

An error compensation method of the camera module 100 and the radar module 200 of the present embodiment will be described with reference to FIGS. 5 to 10 below. FIG. 5 is a flowchart of an overview of an error compensation method according to a present embodiment. Referring to FIG. 5, the error compensation method according to the present embodiment includes (a) measuring an assembly error angle between a center axis of a camera module and a center axis of a radar module after the assembly of the camera module and the radar module (S100), (b) measuring a mounting error angle of one of the camera module and the radar module after mounting the camera module and the radar module in the vehicle (S200), and (c) compensating for a mounting error angle of the other camera or radar module on the basis of the assembly error angle and the mounting error angle of the one of the camera module and the radar module (S300).

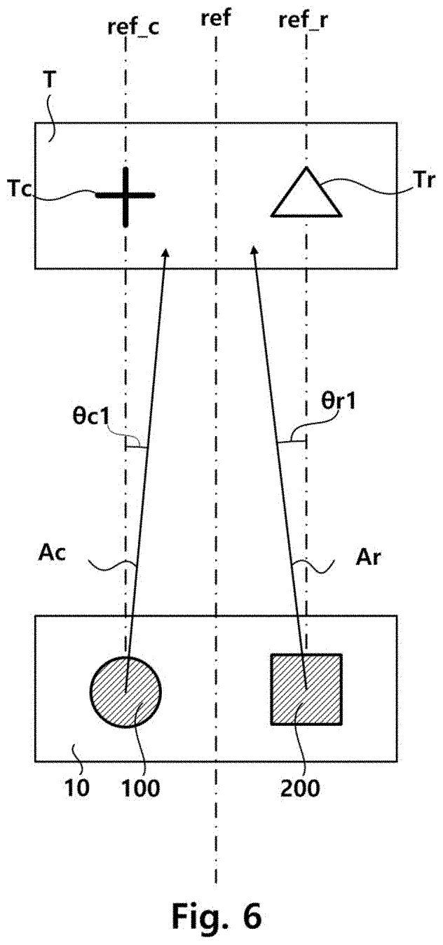

FIG. 6 is a diagram for describing measuring an assembly error angle between a central axis Ac of the camera module 100 and a center axis Ar of the radar module 200 (S100). Referring to FIG. 6, a radar assembly error angle θᵣ₁ between a center axis Ar of the radar module 200 and an ideal center axis ref_r of the radar module 200 and a radar assembly error angle θc1 between a center axis Ac of the camera module 100 and an ideal center axis ref_c of the camera module 100 are measured.

Targets T include a camera target Tc and a radar target Tr. A distance between a center of the camera target Tc and a center of the radar target Tr is the same as a distance between a center of the camera module 100 and a center of the radar module 200. Therefore, when a midpoint in the distance between the center of the camera target Tc and the center of the radar target Tr and a midpoint in the distance between the center of the camera module 100 and the center of the radar module 200 are connected, a reference axis ref between a target T and the sensor system 10 is formed.

When the reference axis ref is parallel translated to pass through the center of the radar module 200, a radar reference axis ref_r is formed, and when the reference axis ref is parallel translated to pass through the center of the camera module 100, a camera reference axis ref_c is formed. The camera reference axis ref_c refers to a center axis of a camera field of view when the camera module 100 is assembled with a housing H1 without an error. Likewise, the radar reference axis ref_f refers to a center axis of a radar field of view when the radar module 200 is assembled with a housing H2 without an error.

Although the camera module 100 and the radar module 200 are manufactured and assembled through precision processes, an actual center axis Ac of the camera module 100 may not coincide with the camera reference axis ref_c and an actual axis Ar of the radar module 200 may not coincide with the radar reference axis ref_r due to an assembly process error or electrical causes such as a signal mismatch as shown in FIG. 6.

A radar assembly error angle θᵣ₁ between the radar reference axis ref_r and the actual center axis Ar of the radar module 200 and a camera assembly error angle θc1 between the camera reference axis ref_c and the actual center axis Ac of the camera module 100 are measured.

An angle is measured with respect to a reference axis. In the embodiment illustrated herein, an angle of deviation θc1 between the camera reference axis ref_c and the actual center axis Ac of the camera module 100 may have a positive value, and an angle of deviation θᵣ₁ between the radar reference axis ref_r and the actual center axis Ar of the radar module 200 may have a negative value. In an embodiment, an offset angle Oo between the measured camera assembly error θc1 and the radar assembly error angle θᵣ₁ is calculated.

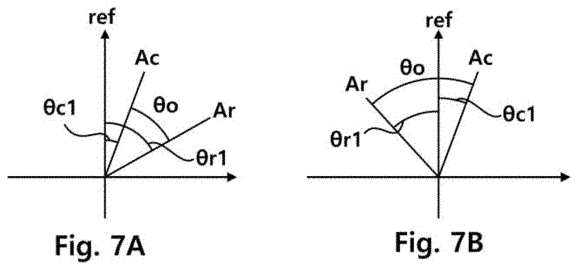

FIG. 7 is a diagram illustrating calculating an offset angle Oo according to an embodiment. As shown in FIGS. 7A and 7B, the offset angle Oo corresponds to an angle between an actual center axis Ac of the camera module 100 and an actual center axis Ar of the radar module 200 when the actual center axis Ac of the camera module 100 and the actual center axis Ar of the radar module 200 are aligned with respect to a reference axis ref. FIG. 7A illustrates a case in which both a measured camera assembly error angle θc1 and a measured radar assembly error angle θᵣ₁ are values with a positive sign, and the offset angle Oo may be calculated to be an absolute value of the difference between the camera assembly error angle θc1 and the radar assembly error angle θr1.

FIG. 7B illustrates a case in which the measured camera assembly error angle θc1 and the measured radar assembly error angle θᵣ₁ are values with different signs.

An offset angle θo formed by the camera assembly error angle Oc 1 and the radar assembly error angle θᵣ₁ with different signs is as shown in FIG. 7B and may be calculated to be an absolute value of the difference between these angles.

The offset angle θo formed by the radar assembly error angle θᵣ₁ and the camera assembly error angle θc1 may be calculated by \textcircled{1} of Equation 1 below, and the radar assembly error angle θr1, and the camera assembly error angle θc1, and the offset angle θo, which are obtained during an assembly process, may be stored and used to compensate for an axis after a mounting process.

[Equation 1]

θo=|θc−θr| \textcircled{1}

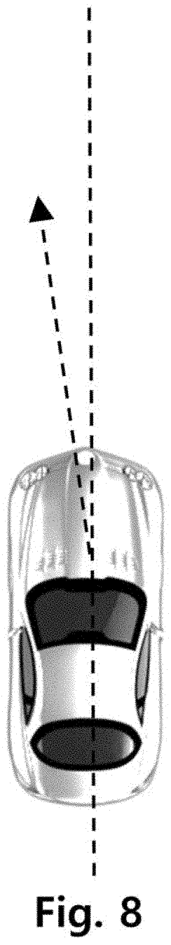

FIG. 8 is a diagram illustrating a case in which a variation corresponding to an angle of installation occurs to both a center axis of a camera module and a center axis of a radar module when the camera module and the radar module are installed. Referring to FIG. 8, the camera module 100 and the radar module 200 are mounted and used in a vehicle. During the mounting of the camera module 100 and the radar module 200, the camera module 100 and the radar module 200 may deviate by the same angle from a center axis of the vehicle. However, the offset angle θo calculated as described above is maintained constant even after the mounting of the camera module 100 and the radar module 200.

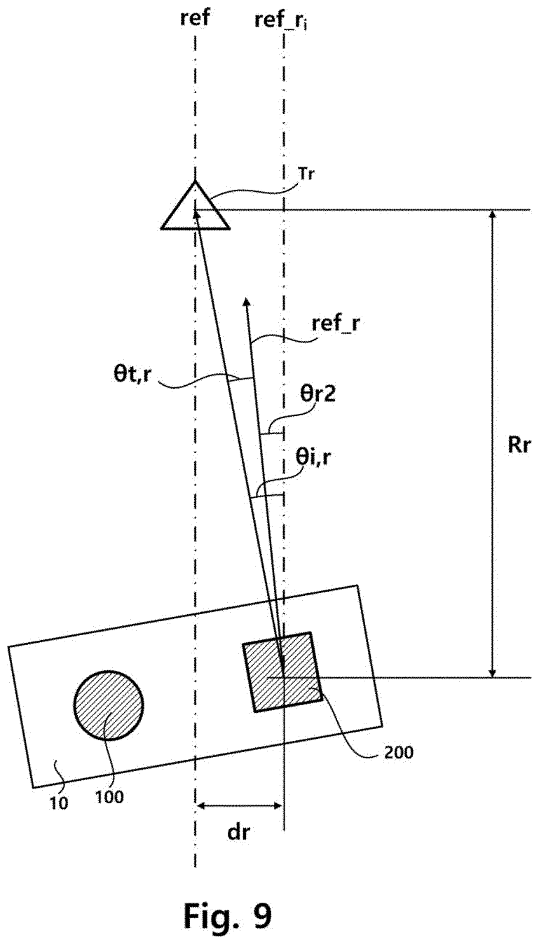

FIG. 9 is a diagram for describing an error compensation process. Referring to FIG. 9, a reference axis ref is an axis connecting a center of a radar target Tr and a center of a sensor system 10 and may coincide with or be parallel with a center axis of a vehicle. An ideal radar reference axis ref_rᵢ is an axis formed by parallel translating the reference axis ref to pass through a center of the radar module 200.

An actual radar reference ref_r is a reference axis of the radar module 200 formed when the sensor system 10 according to the present embodiment is mounted. In an ideal state, the actual radar reference axis ref_r coincides with the ideal radar reference axis ref_rᵢ. However, a mounting error angle θr2 between the actual radar reference axis ref_r and the ideal radar reference axis ref_rᵢ is formed due to a mounting error angle formed by the mounting process and an assembly error angle θᵣ₁ (see FIG. 6) formed during an assembly process. When the center axis of the vehicle and the reference axis ref_coincide with each other due to no error during the mounting process, the mounting error angle θr2 includes only a component of the assembly error angle θᵣ₁ (see FIG. 6).

After mounting the sensor system 10, the mounting error angle θr2 between the actual radar reference axis ref_r and the ideal radar reference axis ref_rᵢ is compensated for. The mounting error angle θr2 is an angle measured counterclockwise from the ideal radar reference axis ref_rᵢ and has a negative value. Accordingly, a mounting error may be compensated for by adding the mounting error angle θr2 to an angle (θt,r) at which the target Tr is viewed.

When the error is compensated for, an angle at which the target Tr is viewed from the radar module 200 is (θi,r). In this case, (θi,r) may be calculated by Equation 2 below based on a distance Rr between the center of the radar module 200 and the center of the target Tr and a distance dr between the center of the radar module 200 and the center of the sensor system 10.

$${θ}_{i , r} = {tan}^{- 1} ( \frac{dr}{Rr} ) \qquad [ Equation 2 ]$$

15

When the mounting error angle θr2 is not compensated for, the angle at which the target Tr is viewed from the radar module 200 is measured to be (θt,r) with respect to the actual radar reference axis ref_r. However, by compensating for the mounting error angle θr2, the angle θt,r at which the target Tr is detected by the radar module 200 is compensated for by θr2 and thus is calculated to be (θt,r+θr2) that coincides with the angle (θi,r) at which the target Tr is viewed from the ideal radar reference axis ref_r₁. By performing compensation as described above, both the axis error θᵣ₁ (see FIG. 6) generated during the assembly process and the mounting error angle θr2 formed due to the mounting process may be compensated for.

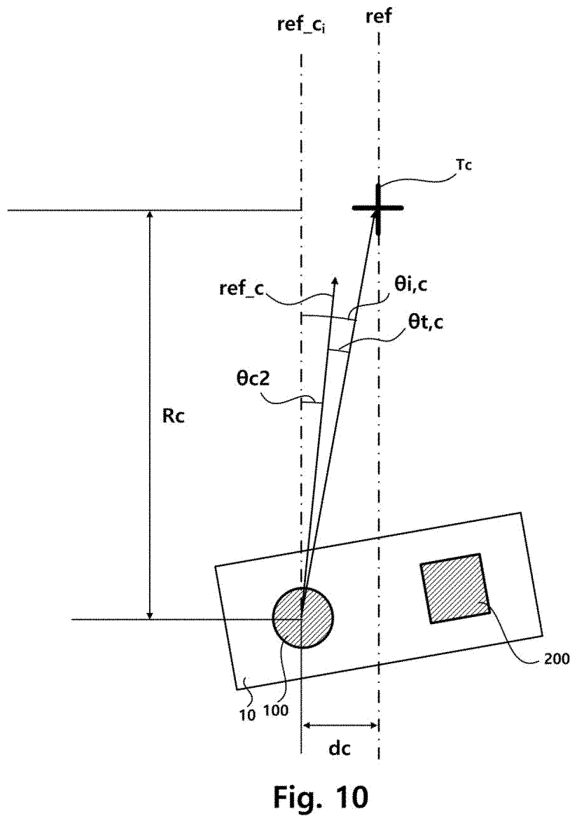

FIG. 10 is a diagram for describing an error compensation process. Referring to FIG. 10, a reference axis ref is an axis connecting a center of a camera target Tc and a center of a sensor system 10 and may coincide with or be parallel with a center axis of a vehicle. An ideal camera reference axis ref_ct is an axis formed by parallel translating the reference axis ref to pass through a center of the camera module 100.

An actual radar reference ref_r is a reference axis of the camera module 100 formed when the sensor system 10 according to the present embodiment is mounted. In an ideal state, the actual camera reference axis ref_c coincides with the ideal camera reference axis ref_cᵢ. However, a mounting error angle θc2 between the actual camera reference axis ref_c and the ideal camera reference axis ref_c₁ is formed due to a mounting error angle formed by the mounting process and an assembly error angle θc1 (see FIG. 6) formed during an assembly process. When the center axis of the vehicle and the reference axis ref coincide with each other due to no error occurring during the mounting process, the mounting error angle θc2 includes only a component of the assembly error angle θc1 (see FIG. 6).

After the mounting of the sensor system 10, the mounting error angle θc2 between the actual camera reference axis ref_c and the ideal camera reference axis ref_cᵢ is an angle measured counterclockwise from the deal camera reference axis ref_cᵢ and has a positive value. Thus, a mounting error may be compensated for by adding the mounting error angle θc2 to an angle (θt,c) at which a target is viewed from the actual camera reference axis ref_c, and (θi,c)=(θt,c)+θc2.

In addition, when an error occurs during the mounting of the sensor system 10 in the vehicle, both the camera module 100 and the radar module 200 are misaligned by the same angle. Therefore, assembly error angles generated during the assembly process are maintained constant after the mounting process. Accordingly, an error angle may be compensated for by \textcircled{1} of Equation 3 below using a mounting error angle of the radar module 200, a camera assembly error angle θc1 measured and stored during the assembly process, and the radar assembly error angle θᵣ₁ without measuring a mounting error angle of the camera module 100.

[Equation 3]

θ_{i,c}=θ_{x,c}+θᵣ₂ =θ_{t,c}+θ_{c1}−θᵣ₁+θᵣ₂ \textcircled{1}

In an embodiment, an offset angle θo (see Equation 1) formed by assembly error angles of the camera module 100 and the radar module 200 may be stored and used to compensate for an error angle of the camera module 100 by achieving the same result as of Equation 3 above even when mounting is performed. For example, when a driver's vehicle equipped with the camera module 100 and the radar module 200 is traveling in the first lane and a vehicle is traveling in an opposite direction across the centerline, it may be identified that the vehicle traveling in the opposite direction is approaching while traveling the wrong way in the same lane as the driver's vehicle when an error angle is not calculated or inaccurately calculated, thereby generating a wrong warning and resulting in a big accident.

However, according to the error compensation method of the present embodiment, errors generated during manufacturing and assembling processes and an error generated when the camera module 100 and the radar module 200 are mounted in a vehicle may be more accurately compensated for, thereby more exactly identifying an object.

As described above, the error angle Or2 includes both the error angle θᵣ₁ due to an axis error generated during the assembling process and an error angle generated due to the mounting process. As described above, during the compensation for of the error angle Or2, both the error angle θᵣ₁ due to an axis error generated during the assembling of the radar module 200 and an error angle generated due to the mounting process may be compensated for, values of axis errors generated during the assembly process may be stored, and both an error when a camera module is mounted and a manufacturing error of the camera module may be fixed on the basis of the values.

According to the present embodiment, a camera module and a radar module are installed in a cabin of a vehicle to reduce effects when installed outside the vehicle and reduce a data transmission length, thereby increasing a data transmission and reception rates and a transmission speed.

Although the embodiments illustrated in the drawings have been described above to help understand the present disclosure, these embodiments are only examples and it will be apparent to those of ordinary skill in the art that various modifications may be made and other equivalent embodiments are derivable from the embodiments. Therefore, the scope of the present disclosure should be defined by the appended claims.

What is claimed is:

1. A sensor system comprising:
a camera module; and
a radar module,
wherein the camera module and the radar module are separately and detachably housed, and
the sensor system is mounted in a cabin of a vehicle.

2. The sensor system of claim 1, wherein a data transceiving connector is provided at positions corresponding to a camera housing for housing the camera module and a radar housing for housing the radar housing.

3. The sensor system of claim 1, wherein the radar module comprises a radar processor configured to calculate a position and movement information of an object from radio waves reflected from the object,
the camera module comprises a camera processor configured to calculate the position and movement information of the object from a captured image, and
the camera processor receives the position and movement information of the object that are calculated by the radar processor, and creates and outputs a driver warning with respect to the object.

4. The sensor system of claim 1, wherein the sensor system is mounted on a windshield of the vehicle.

5. The sensor system of claim 1, wherein the camera module comprises one of a first camera module and a second camera module with different field-of-view (FOV) angles, and
the radar module comprises one of a first radar module and a second radar module with different detection ranges.

6. The sensor system of claim 5, wherein the detection range of the first radar module is less than 100 nm, and
the detection range of the second radar module is 100 nm or more.

7. The sensor system of claim 5, wherein the first radar module uses radio waves of 79 GHz band, and
the second radar module uses radio waves of 77 GHz band.

8. The sensor system of claim 5, wherein the first radar module comprises one of two-dimensional (2D) radar, three-dimensional (3D) radar, and four-dimensional (4D) radar, and the second radar module comprises another one of the 2D radar, the 3D radar, and the 4D radar.

9. The sensor system of claim 5, wherein the FOV angle of the first camera module is less than 60 degrees, and
the FOV angle of the second camera module is 60 degrees or more.

10. The sensor system of claim 5, wherein the first camera module has a resolution of less than FHD (1920×1080), and
the second camera module has a resolution of FHD (1920×1080) or more.

11. The sensor system of claim 1, wherein the radar module comprises:
a transmitter configured to transmit radio waves;
a receiver configured to receive radio waves reflected from an object;
a radar processor configured to control the transmitter to transmit the radio waves, and calculate at least one of a distance to the object, a size of the object, and a speed of the object from the reflected radio waves; and
a radar interface configured to output information about the speed of the object, the size of the object, and the distance to the object that are calculated by the radar processor.

12. The sensor system of claim 11, wherein the radar interface comprises one of a wired communication interface and a wireless communication interface.

13. The sensor system of claim 1, wherein the camera module comprises:
an imaging unit configured to capture an image of a moving direction of the vehicle;
a camera processor configured to calculate whether there is an object, a speed of the object, and a distance to the object from the captured image; and
a camera interface configured to output information about whether there is an object, the speed of the object, and the distance to the object that are calculated by the camera processor.

14. The sensor system of claim 13, wherein the camera interface comprises one of a wired communication interface and a wireless communication interface.

15. The sensor system of claim 1, wherein the radar module comprises a radar processor configured to calculate a position and movement information of an object from radio waves reflected from the object,
the camera module comprises a camera processor configured to calculate the position and movement information of the object from a captured image, and
the radar processor receives information about the position and movement information of the object that are calculated by the camera processor, and creates and outputs a driver warning with respect to the object.

16. An error compensation method of a camera module and a radar module, comprising:
(a) measuring a camera assembly error angle of the camera module and a radar assembly error angle of the radar module after assembling the camera module and the radar module;
(b) measuring a mounting error angle of one of the camera module and the radar module after mounting the camera module and the radar module in a vehicle; and
(c) compensating for the mounting error angle of the other camera module or radar module on the basis of the camera assembly error angle, the radar assembly error angle, and the mounting error angle of the one of the camera module and radar module.

17. The error compensation method of claim 16, wherein (a) comprises:
(a1) measuring an error angle between an ideal center axis and an actual center axis of the camera module; and
(a2) measuring an error angle between an ideal center axis and an actual center axis of the radar module.

18. The error compensation method of claim 16, wherein (b) is performed by measuring an angle between an ideal reference axis and an actual reference axis of the one of the camera module and the radar module.

19. The error compensation method of claim 16, wherein an error is compensated for by compensating for angles of a target detected by the radar module and the camera module on the basis of the mounting error angle of the one of the camera module and the radar module and the mounting error angle of the other camera module or radar module.

20. The error compensation method of claim 16, wherein, in (c), the compensating-for mounting error angle of the other camera module or radar module is expressed by:
θ_{i,c}=θ_{t,c}+θ_{c1}−θᵣ₁+θᵣ₂ \textcircled{1}
wherein θ_{i,c} denotes a detected target angle of the other camera module or radar module, the mounting error angle of which is compensated for, θ_{t,c} denotes a detected target angle of the other camera module or radar module, the mounting error angle of which is not compensated for, θ_{c1} denotes an assembly error angle of the other camera module or radar module, θᵣ₁ denotes an assembly error angle of the one of the camera module and the radar module, and θᵣ₂ denotes a mounting error angle of the one of the camera module and the radar module.
